(19) United States
(12) Patent Application Publication
(10) Pub. No.: US 2007/0160112 A1
(43) Pub. Date: Jul. 12, 2007

(54) THERMOMETER

(76) Inventor: Puneet Nanda, Cerritos, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/567,672

(22) Filed: Dec. 6, 2006

Related U.S. Application Data
(60) Provisional application No. 60/742,748, filed on Dec. 6, 2005.

(51) Int. Cl. G01K 7/00; G01K 1/00

(52) U.S. Cl. 374/163; 374/208

(57) ABSTRACT

A thermometer includes an elongated body comprising a tip, one or more illumination elements that outputs light and a timing device configured to measure a period of time. The tip of the thermometer is configured to measure a bodily temperature when placed within or near a person's anatomy. Further, the illumination element may be positioned on or within the elongated body. In some embodiments, the illumination element, which is configured to output light after a period of time has elapsed, can be incorporated into an ornamental element.

### PRIORITY INFORMATION

This application claims priority to U.S. Provisional Application Ser. No. 60/742,748, filed Dec. 6, 2005, the entirety of which is hereby incorporated by reference.

### BACKGROUND OF THE INVENTIONS

1. Field of the Inventions

The present invention relates to thermometers and, more particularly, to thermometers with indicator systems.

2. Description of the Related Art

Thermometers are normally used to determine the internal body temperature of a person. Simple mercury thermometers can be inserted in or near a person's anatomy to obtain a temperature measurement. Alternatively, electronic thermometers have been introduced which emulate the linear structure of the basic mercury thermometer. A numerical display is usually disposed on electronic thermometers to assist in reading the measured temperature.

### SUMMARY OF THE INVENTION

A thermometer can be used to measure a person's temperature. The thermometer has a distal tip that can be placed in a person's mouth to orally measure the person's temperature. A digital display displays the measured temperature. The thermometer also includes an indicator system that preferably includes an illumination element (e.g., one or more lights). The illumination element can be activated after a predetermined length of time has passed (e.g., a length of time corresponding to a time period required to take an accurate temperature measurement). An ON/OFF and/or reset button can be positioned at any location along the thermometer. To measure a person's temperature, the distal tip can be placed in a person's mouth, preferably placed under a person's tongue. After a suitable measuring period has passed, the indicator system can be activated to alert a person that a temperature measurement has been taken. The measured temperature can then be read from the display.

In some embodiments, a thermometer includes a distal end that can be placed in a person's mouth. The thermometer has an elongate body that comprises an indicator system that can be activated to provide notification that a period of time has passed. In some variations, the body can house a power source that delivers energy to at least one illumination element. In some variations, the elongate body comprises a plurality of illumination elements. A timing system and a temperature measuring system can be positioned within a body. After the thermometer has been placed in a person's mouth for a desired length of time, the timing system can send a signal that causes activation of the indicator system so as to indicate that the person's temperature has been measured. In some variations, the thermometer has a display for indicating a measured temperature.

In another embodiment, a thermometer comprises an elongate body and a distal tip. The distal tip is sized and configured to be placed under a person's tongue. The elongate body comprises an indicator system for notifying a person after a period of time has passed. In some embodiments, the indicator system can provide feedback to a person that uses the thermometer. The indicator system can include one or more lights, vibrating elements (e.g., a rotating unbalanced mass), auditory system (e.g., a speaker), articulating device (e.g., an articulating arm), a visual display, and combinations thereof These can be used to alert a person that the thermometer has been left in a person a suitable length of time. A timing mechanism can measure how long the thermometer has been in a person's mouth. The indicator system can be activated after the timing mechanism measures a suitable length of time. The thermometer can be used to determine a person's temperature after the thermometer notifies a person that the thermometer has been placed in a person's mouth for a suitable length of time.

In some embodiments, a thermometer comprises an elongated body comprising a tip, at least one illumination element configured to output light and a timing device configured to measure a period of time. The tip is configured to measure a bodily temperature when placed within or near a person's anatomy. Further, the illumination element is positioned on or within the elongated body. The illumination element is configured to output light when a period of time has elapsed. The illumination element can be incorporated into one or more ornamental elements of the thermometer.

In one embodiment, the thermometer further comprises at least one button, which is configured to activate the timing device. In other embodiments, the thermometer further comprises one or more sensors that are configured to activate the timing device. In some embodiments, the sensor is a motion sensor, a temperature sensor, a moisture sensor and/or the like.

In one embodiment, the tip of the thermometer comprises a temperature sensing element. In some embodiments, the tip is configured to be placed inside a person's mouth. In other embodiments, the tip comprises a bulb of a mercury thermometer. In yet other embodiments, the thermometer comprises a thermocouple which is configured to measure a bodily temperature.

In one embodiment, the thermometer additionally includes one or more displays that are configured to provide a temperature measurement. In some embodiments, a display comprises one or more LEDs. In another embodiment, the illumination element is configured to remain continuously activated for a predetermined time period. In still other embodiments, the illumination element is configured to flicker or pulse. In some embodiments, the illumination element is incorporated into at least one ornamental or aesthetic element. In one embodiment, the ornamental element is a cartoon character.

In one embodiment, the illumination element comprises a plurality of light sources. In some embodiments, the light sources comprise two or more different colors, such as, for example, orange light, blue light, red light, green light, or any other colored light. In some embodiments, the illumination element and the timing device are powered by a battery which is configured for placement within the elongated body of the thermometer.

In other embodiments, a thermometer includes an elongated body comprising a tip, a timing device configured to measure a period of time and one or more sensory devices configured to alert a user that a temperature has been properly measured. The tip may be configured to measure a bodily temperature when placed within or near a person's anatomy. Further, a sensory device may be configured to be activated after a period of time has elapsed. In one embodiment, the sensory device includes an auditory system, a mechanical movement device, a vibrating element and/or the like.

### BRIEF DESCRIPTION OF THE DRAWINGS

FIG. 1 is a front elevation view of a thermometer according to one embodiment.

FIG. 2 is a schematic block diagram of components of the thermometer of FIG. 1 according to one embodiment.

### DETAILED DESCRIPTION OF THE PREFERRED EMBODIMENTS

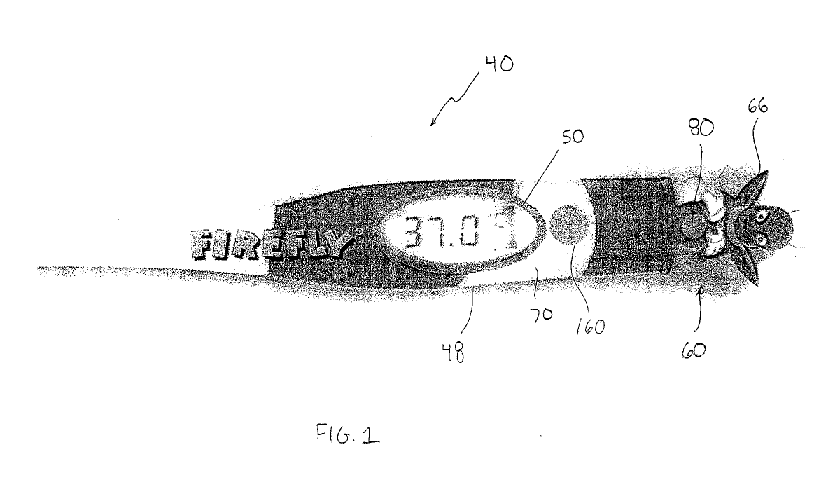

FIG. 1 illustrates a thermometer 40 that can be used to measure a person's temperature. The thermometer 40 can include a tip 42 and an elongate body 48. The elongate body 48 may preferably have a display 50 and an indicator system 60 that can provide feedback to a person that uses the thermometer. The indicator system 60 can inform a person how long the thermometer has been measuring a temperature. In some embodiments, the indicator system 60 has an ornamental element 66 having an eye-catching appearance. The illustrated element 66 is in the form of a character (e.g., cartoon character, animal, car, bug, etc.) but the element 66 can have other configurations.

The thermometer 40 can be used to measure the temperature of a person to determine whether the person has a normal temperature, fever, etc. For example, a normal body temperature can be about 37° C. (98° F.) when taken orally. Body temperatures taken by other means (e.g., rectally) can be at other temperatures. For example, the body temperature taken rectally is generally about 5° C. higher than those temperatures taken orally. The thermometer 40 can be used to take a person's temperature orally, rectally, or by any other suitable means.

To take a person's temperature, the tip 42 can be placed within or near a person's body (e.g., mouth, rectum, underarm, ear, etc.). After the thermometer 40 has been left in the person's body a suitable length of time, the temperature of the person can be read from the display 50. The indicator system 60 can be activated to alert a person (e.g., the person whose temperature is being measured or another person). Thus, the indicator system 60 can provide feedback that indicates that the thermometer 40 has remained in the person for a suitable length of time to measure the temperature accurately. This can ensure that the thermometer is not removed prematurely. Additionally, the indicator system 60 can be utilized to minimize any excess time that the thermometer 40 remains in the person's body.

With continued reference to FIG. 1, the tip 42 is sized and configured to fit within a person's body. The illustrated tip 42 is configured to be placed under a person's tongue. However, the tip 42 can be placed under a person's arm, in a person's rectum, or other suitable location for taking a temperature. The size of the tip 42 can be increased or decreased depending on the location in which a temperature is measured. In some embodiments, the tip 42 can be a bulb of a mercury thermometer. However, in other embodiments, the tip 42 can have a thermocouple or other suitable temperature measuring device. The illustrated tip 42 is an elongated, blunt tip that is in communication with a temperature measuring system disposed in the housing of the thermometer 40. Metal, plastic, and/or other suitable materials can be used to form the tip 42.

The elongated body 48 is preferably sized such that it extends out of or from a person's mouth or other body part when the tip 42 is placed in or near a person's anatomy. The elongate body 48 can have an outer housing 70. The housing 70 can protect and surround internal components of the thermometer 40. A button 160 may be positioned along the elongate body 48. The button 160 can be an ON/OFF button. Alternatively or additionally, the button 160 can be a reset button and/or any other type of button.

A display 50 can be positioned along one or more portions of the elongated body 48. The display 50 preferably indicates the measured temperature. In the illustrated embodiment, the display 50 is a digital display that provides the measured temperature in degrees Celsius. However, it will be appreciated that the temperature can be displayed in other units, such as, for example, degrees Fahrenheit.

The indicator system 60 can be in the form of an illumination system that can be activated to alert a person after a period of time has passed. In the illustrated embodiment of FIG. 1, the indicator system 60 comprises a single illumination element 80 that can be activated. The illumination element 80 can flicker, pulse, remain continuously activated for a desired length of time, or may have a program sequence of activation. The illumination element 80 can make taking temperature measurements more enjoyable, indicate that the thermometer 40 has measured a temperature for a sufficient length of time, and the like. Additionally, the illumination element 80 can comprise a plurality of light sources of various colors. If desired, the light sources can output orange light, blue light, red light, green light, or any other colored light.

In some embodiments, a combination of different colors can be used and/or the different colors can be activated in a desired timing pattern. Of course, various colored materials can be employed with light sources to create light of a desired color. For example, if a person has a fever, the element 80 can emit red light. If a person has a normal temperature, the element 80 can emit green light. If a person has a low temperature, the element 80 can emit blue light. In some embodiments, the indicator system 60 comprises one or more LEDs. The indicator system 60 can be positioned at various locations. Preferably, the indicator system 60 is positioned such that a person can see the indicator system 60 when the thermometer 40 is taking a person's temperature. If the thermometer 40 is configured to be used orally, the indicator system 60 can be at the end of the elongate body 48. In such embodiment, the indicator system 60 can be outside of a person's mouth when taking a temperature measurement. Accordingly, the indicator system 60 can easily alert the person using the thermometer 40.

The illustrated indicator system 60 comprises the element 66 in the form of a fly. However, the element 66 can be in the shape of any animal, landmark, or other design. These types of elements may reduce apprehension of a person, especially children, using the thermometer.

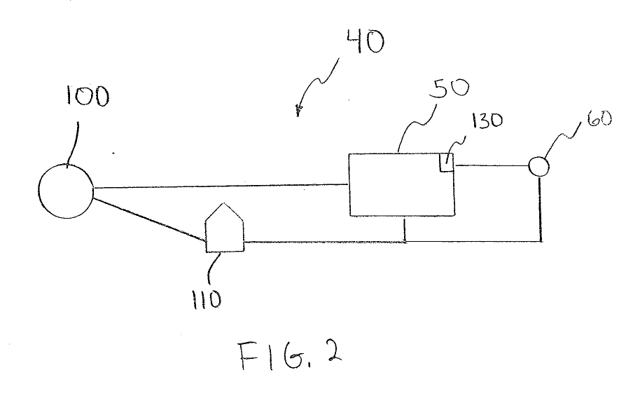

FIG. 2 is a block diagram of some of the components of the thermometer 40. The thermometer 40 has a temperature sensing element 100 that is in communication with the display system 50. The display system 50 and the temperature sensing element 100 can be powered by a power source 110. The indicator system 60 can also be powered by the power source 110. The temperature sensing element 100 is preferably disposed within a tip 42. When the tip 42 is placed in a patient, the temperature sensing element 100 can accurately measure the person's temperature. The display system 50 can include a controller that receives a signal from the temperature sensor 100 and then displays a temperature based on that signal. The display 50 can then cause the indicator light 80 to alert a user after the thermometer 40 has been used a desired length of time.

The power supply 110 can provide power to any number of components of the thermometer 40. The illustrated power supply 110 provides power to the temperature sensor 100, the display 50, and the indicator system 60. The power supply 110 can comprise one or more batteries or any energy source device for powering the thermometer 40 (e.g., solar panel).

The thermometer 40 can comprise a timing device 130 that can measure a length of time. The timing device 130 can comprise a clock, timer (including a mechanical or electronic timer), or other timing device. After a predetermined length of time has elapsed, the timing device 130 can cause activation of the indicator system 60 to indicate that the thermometer 40 has been in or near a person's body a suitable length of time to measure the person's temperature. The timing device 130 can start to measure the length of time based on a user input, such as by depressing a button 160 on the thermometer 40. Alternatively, the timing device 130 can start measuring after the temperature sensor 100 measures a particular temperature. In other embodiments, the timing device 130 can be initiated after detecting a temperature change, after detecting moisture (e.g., saliva), after being handled and/or by any other method. Thus, the thermometer can comprise one or more moisture sensors, temperature sensors, motion sensors and/or the like to appropriately alert the timing device. The sensor can be positioned within and/or or the surface of the tip, elongated body or other portion of the thermometer.

To use the thermometer 40, a person can place the tip 42 in or near the desired portion of a person's body. After the tip 42 is located in a desired position, the thermometer 40 can be left in place. The timing mechanism 130 can measure a length of time corresponding to a desired measuring time period. Preferably, the measuring time period corresponds to the time required for the thermometer 40 to accurately measure a person's body temperature. After the measuring time period has elapsed, the timing mechanism 130 can activate the indicator system 60. The activated indicator system 60, for example, can be energized by the energy source 110 to alert a person that the thermometer 40 has measured the person's temperature. In some embodiments, the indicator 60 can activate a light.

In other embodiments, the indicator system 60 can comprise an auditory device that beeps or makes a noise indicating that a desired length of time has passed. However, the indicator system 60 can also comprise one or more other sensory devices for providing cues to a person that a temperature has been measured, such as, for example, vibrating elements (e.g., a rotating unbalanced mass), auditory system (e.g., a speaker), articulating device (e.g., an articulating arm), other mechanical movement device, a visual display, and/or combinations thereof Additionally, the indicator system 60 can provide an enhanced temperature measuring experience. For example, the indicator 60 can flash or remain illuminated so that a person using the thermometer 40 is distracted by and/or enjoys the temperature measuring process. The indicator 60 can also change colors once the measuring time period has passed.

The various features and steps discussed above, as well as other known equivalents for each such feature or step, can be mixed and matched by one of ordinary skill in this art to perform methods in accordance with principles described herein. Additionally, the methods which is described and illustrated herein is not limited to the exact sequence of acts described, nor is it necessarily limited to the practice of all of the acts set forth. Other sequences of events or acts, or less than all of the events, or simultaneous occurrence of the events, may be utilized in practicing the embodiments of the invention.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof Accordingly, the invention is not intended to be limited by the specific disclosures of preferred embodiments herein.

What is claimed is:

1. A thermometer comprising:
an elongated body comprising a tip, the tip configured to measure a bodily temperature when placed within or near a person's anatomy;
at least one illumination element configured to output light, the illumination element positioned on or within the elongated body; and
a timing device configured to measure a period of time;
wherein after the period of time has elapsed, the illumination element is configured to output light; and
wherein the illumination element is incorporated into at least one ornamental element.

2. The thermometer of claim 1, further comprising at least one button, the button configured to activate the timing device.

3. The thermometer of claim 1, further comprising at least one sensor, the sensor configured to activate the timing device.

4. The thermometer of claim 3, wherein the sensor is a motion sensor, a temperature sensor or a moisture sensor.

5. The thermometer of claim 1, wherein the tip comprises a temperature sensing element.

6. The thermometer of claim 1, wherein the tip is configured to be placed inside a person's mouth.

7. The thermometer of claim 1, wherein the tip comprises a bulb of a mercury thermometer.

8. The thermometer of claim 1, wherein the thermometer comprises a thermocouple, the thermocouple configured to measure a bodily temperature.

9. The thermometer of claim 1, further comprising at least one display, the display configured to provide a temperature measurement.

10. The thermometer of claim 9, wherein the display comprises an LED.

11. The thermometer of claim 1, wherein the illumination element is configured to remain continuously activated for a predetermined time period.

12. The thermometer of claim 1, wherein the illumination element is configured to flicker or pulse.

13. The thermometer of claim 1, wherein the ornamental element comprises a cartoon character.

14. The thermometer of claim 1, wherein the illumination element comprises a plurality of light sources.

15. The thermometer of claim 14, wherein the plurality of light sources comprise at least two different colors.

16. The thermometer of claim 1, wherein the illumination element and the timing device are powered by at least one battery, the battery configured for placement within the elongated body of the thermometer.

17. A thermometer comprising:
an elongated body comprising a tip, the tip configured to measure a bodily temperature when placed within or near a person's anatomy;
a timing device configured to measure a period of time; and
at least one sensory device configured to alert a user that a temperature has been properly measured;
wherein after the period of time has elapsed, the sensory device is configured to be activated; and
wherein the sensory element is incorporated into at least one ornamental element

18. The thermometer of claim 17, wherein the sensory device comprises an auditory system.

19. The thermometer of claim 17, wherein the sensory device comprises a mechanical movement device.

20. The thermometer of claim 17, wherein the ornamental element comprises a cartoon character.
